(19) United States
(12) Patent Application Publication
(10) Pub. No.: US 2024/0099341 A1
(43) Pub. Date: Mar. 28, 2024

(54) METHOD FOR PRODUCING GRAIN MIXED GROUND MEAT, GRAIN PROCESSED FOOD, AND GRAIN MIXED GROUND MEAT

(71) Applicant: NIPPON FOOD MANUFACTURER, Sapporo-shi Hokkaido (JP)

(72) Inventor: Ken Luis TOBE, Sapporo-shi Hokkaido (JP)

(73) Assignee: NIPPON FOOD MANUFACTURER, Sapporo-shi Hokkaido (JP)

(21) Appl. No.: 18/003,096

(22) PCT Filed: May 9, 2022
(86) PCT No.: PCT/JP2022/019655

§ 371 Date: Dec. 22, 2022

(30) Foreign Application Priority Data
Jun. 21, 2021 (JP) 2021-102106

(51) Int. Cl. A23L 13/40; A23L 7/10; A23L 13/60

(52) U.S. Cl. CPC A23L 13/426; A23L 7/197; A23L 7/198; A23L 13/60

(57) ABSTRACT

A method for producing grain mixed ground meat includes a step (A) of simmering grain having been shed and polished; a step (B) of flaking the grain having been simmered in the foregoing step; a step (C) of drying or roasting the grain having been flaked in the foregoing step to obtain grain processed food; and a step (D) of mixing the grain processed food obtained in the foregoing step with ground meat to obtain grain mixed ground meat.

### TECHNICAL FIELD

The present invention relates to a method for producing grain mixed ground meat, grain processed food, and grain mixed ground meat.

### BACKGROUND ART

Meat-like food such as a 100% vegetable based hamburger and sausage not containing meat but made from soy beans or konjac is demanded to some extent by not only kidney disease patients under restriction of protein intake but also vegetarians and health conscious consumers.

As an example of a method for producing such meat-like food, Patent Literature 1 describes a method for producing low-protein meat-like food containing insoluble dietary fiber of barley, corn, or the like, and a konjac flour.

On the other hand, there are needs for enjoying meat diet in consideration of health consciousness although 100% vegetable based meat-like food is not needed but meat diet is not denied. In such a case, for reducing the amount of meat to be used, ingredients other than meat can be mixed with meat (particularly, ground meat of beef, pork, chicken or the like). When ingredients used in conventional meat-like food are mixed with ground meat in a prescribed ratio, however, the original texture, flavor, and appearance of meat may be impaired in some cases. Besides, for example, when whole grains are directly mixed with ground meat, the resultant texture and flavor become different from those of the original meat, and since the grain shape of the mixed grain can be visually recognized, the appearance may be different in some cases. In addition, for example, when a powder of grain such as flour is mixed, the powder absorbs moisture to be changed to a paste, which may impair the texture and flavor, and appearance in some cases.

### CITATION LIST

### Patent Literature

[Patent Literature 1] Japanese Patent Laid-Open No. 2011-142881

### SUMMARY OF INVENTION

### Technical Problem

Development of novel food capable of reducing the amount of ground meat to be used, and retaining the original texture, flavor and appearance of ground meat has been expected.

The present invention was devised in consideration of these circumstances, and an object is to provide a method for producing grain mixed ground meat, grain processed food, and grain mixed ground meat in which texture, flavor and appearance can be adjusted, the amount of ground meat to be used can be reduced, and a nutrient of grain can be added.

### Solution to Problem

For achieving the above-described object, a method for producing grain mixed ground meat according to a first aspect of the present invention includes: a step (A) of simmering grain having been shed and polished; a step (B) of flaking the grain having been simmered in the foregoing step; a step (C) of drying or roasting the grain having been flaked in the foregoing step to obtain grain processed food; and a step (D) of mixing the grain processed food obtained in the foregoing step with ground meat to obtain grain mixed ground meat.

For example, the grain is flaked to a thickness of 0.3 to 2.4 mm in the step (B).

For example, the method further includes a step of cutting the grain.

For example, the grain is simmered in the step (A) after the grain having been shed and polished is cut.

For example, the grain is cut in the step (C) to obtain the grain processed food after the grain having been flaked in the step (B) is dried or roasted.

For example, the grain is cut into 2 to 15 pieces, or cut into a size of 1.5 to 12.0 mm in terms of a sieve opening size.

Grain processed food according to a second aspect of the present invention is grain process food having been simmered and flaked to be mixed with ground meat.

Grain processed food according to a third aspect of the present invention is grain processed food having been simmered, flaked, and cut to be mixed with ground meat.

Grain processed food according to a fourth aspect of the present invention is grain processed food having been simmered and flaked and having a thickness of 0.3 to 2.4 mm to be mixed with ground meat.

Grain mixed ground meat according to a fifth aspect of the present invention includes the grain processed food according to any one of the second to fourth aspects of the present invention.

### Advantageous Effects of Invention

According to the present invention, a method for producing grain mixed ground meat, grain processed food, and grain mixed ground meat in which texture, flavor and appearance can be adjusted, an amount of ground meat to be used can be reduced, and a nutrient of grain can be added can be provided.

### BRIEF DESCRIPTION OF DRAWINGS

FIG. 1 illustrates diagrams exemplifying production processes of grain processed food used in grain mixed ground meat of the present invention, wherein FIG. 1(a) is a diagram illustrating a production process (of cutting after drying) of grain processed food obtained using oats, FIG. 1(b) is a diagram illustrating a production process (of cutting between shedding/polishing and simmering) of the grain processed food obtained using oats, FIG. 1(c) is a diagram illustrating a production process (cutting after drying or roasting) of the grain processed food obtained using barley, and FIG. 1(d) is a diagram illustrating a production process (cutting before simmering) of the grain processed food obtained using barley.

FIG. 2 is a photograph of a cooked hamburger of an example.

FIG. 3 is a photograph of a cooked hamburger of an example.

FIG. 4 is a photograph of a cooked shaomai of an example.

FIG. 5 is a photograph of a cooked meatball of an example.

FIG. 6 illustrates photographs of oats processed food of an example, wherein FIG. 6(a) is a photograph of the food obtained by cutting into 2 pieces, FIG. 6(b) is a photograph of the food obtained by cutting into 4 pieces, and FIG. 6(c) is a photograph of the food obtained by cutting into 6 pieces.

FIG. 7 illustrates photographs of oats processed food of an example, wherein FIG. 7(a) is a photograph of the food obtained by flaking to 0.4 mm/cutting into 2 pieces, FIG. 7(b) is a photograph of the food obtained by flaking to 0.4 mm/cutting into 6 pieces, FIG. 7(c) is a photograph of the food obtained by flaking to 0.9 mm/cutting into 2 pieces, FIG. 7(d) is a photograph of the food obtained by flaking to 0.9 mm/cutting into 6 pieces, FIG. 7(e) is a photograph of the food obtained by flaking to 1.2 mm/cutting into 2 pieces, and FIG. 7(f) is a photograph of the food obtained by flaking to 1.2 mm/cutting into 6 pieces.

FIG. 8 is a photograph of corn processed food of an example.

FIG. 9 illustrates photographs of corn processed food of an example, wherein FIG. 9(a) is a photograph of the food obtained by flaking to 0.5 mm, FIG. 9(b) is a photograph of the food obtained by flaking to 0.8 mm, and FIG. 9(c) is a photograph of the food obtained by flaking to 1.2 mm.

FIG. 10 illustrates photographs of corn processed food of an example, wherein FIG. 10(a) is a photograph of the food obtained by flaking to 0.5 mm, FIG. 10(b) is a photograph of the food obtained by flaking to 0.8 mm, and FIG. 10(c) is a photograph of the food obtained by flaking to 1.2 mm.

### DESCRIPTION OF EMBODIMENTS

### (1. Method for Producing Grain Mixed Ground Meat)

A method for producing grain mixed ground meat of the present invention includes:
a step (A) of simmering grain having been shed and polished,
a step (B) of flaking the grain having been simmered in the foregoing step,
a step (C) of drying or roasting the grain having been flaked in the foregoing step to obtain grain processed food, and
a step (D) of mixing the grain processed food obtained in the foregoing step with ground meat to obtain grain mixed ground meat.

By the method for producing grain mixed ground meat of the present invention, grain mixed ground meat in which texture, flavor and appearance can be adjusted, an amount of ground meat to be used can be reduced, and a nutrient of grain can be added can be produced.

Examples of the grain used in the present invention include not only grains of the Poaceae family such as brown rice, barley, wheat, oats, rye, adlay, millet, Japanese barnyard millet, and corn but also buckwheat, Amaranthus, quinoa, and soy beans. Herein, the “grain having been shed and polished” may be precedently processed grain, and encompasses, for example, corn grits, cornmeal, rolled oats and the like.

In the step (A), the grain having been shed and polished is simmered. Since the grain is made soft and elastic by adding moisture thereto through the simmering, the grain can be rolled out without being crushed by flaking in the step (B) described below. After polishing, drying by heating may be performed for purposes of stabilizing bran present on the surfaces of grains, and the drying by heating can be employed when the grains are temporarily stored or when a batch operation is required. In such a case, the simmering can be performed after the drying by heating. Besides, the grain may be cooled after the simmering, or a water content and a temperature may be adjusted to desired extents.

As a specific method for the simmering, for example, the simmering may be performed under steam (100° C.) for several tens of minutes, or may be performed under pressure of 1 atm or more at a temperature of 100° C. or more for 30 minutes or more. In consideration of the type of the grain, and a mixing ratio with ground meat, the method can be appropriately changed.

In the step (B), the grain having been simmered in the step (A) is flaked. Examples of a specific method for the flaking include a method in which the grain is caused to pass between rotating rollers to be flaked, and a method in which a flat plate of an iron plate or the like is pressed against the grain for flaking. The grain is flaked to a thickness of, for example, 0.3 to 2.4 mm.

In the step (C), the gran having been flaked in the step (B) is dried or roasted to obtain grain processed food.

Examples of a specific method for the drying include a hot air drying method; a roasting method on a heated iron plate or the like; a drying method under reduced pressure; a sun drying method; a natural drying method; and a freeze drying method, and the method can be appropriately selected in consideration of the type of the grain, a mixing ratio with ground meat, and the like. It is noted that the drying may be performed to obtain a moisture value in the grain of 14% or less.

Examples of a specific method for the roasting include a hot air blasting method; a roasting method on a heated iron plate or the like; and a method using direct heating, a heat ray or the like. It is noted that the grain may be swollen when roasted. Besides, for purposes of, for example, increasing aroma; adjusting texture; or adjusting appearance color, a step of further roasting the grain (for example, at 120° C. or more for 5 seconds or more) may be included after roasting or after swelling through roasting.

The method for producing grain mixed ground meat of the present invention may include a step of cutting the grain.

When the step of cutting the grain is included, for example, the grain having been shed and polished may be cut, and then simmered in the step (A), or the grain having been flaked in the step (B) is dried or roasted and then cut in the step (C) to obtain grain processed food.

Examples of a specific method for the cutting include a method using a cutting blade (cutting machine); a method in which the grain is smashed against some sort of surface to be crushed, and the resultant is sifted; and a method in which the grain is pressed against a sieve, and the method can be appropriately selected in consideration of the type of the grain, a mixing ratio with ground meat, and the like.

When the step of cutting the grain is included, the grain may be cut into 2 to 15 pieces, or cut into a size of 1.5 to 12.0 mm in terms of a sieve opening size. The cutting size can be appropriately selected in consideration of the type of the grain, a mixing ratio with ground meat, texture and the like.

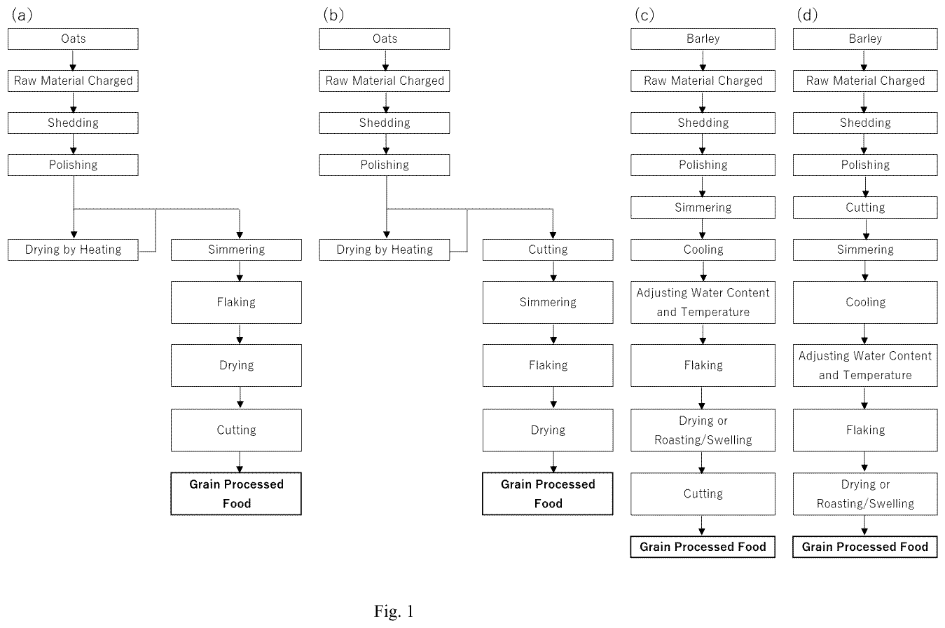

Processes before obtaining grain processed food will be described by exemplarily illustrating the processes in FIG. 1.

An example of processes for obtaining grain processed food using oats will be described (FIG. 1(a)). Oats are charged in a shedding apparatus to remove hull (shedding), and then, the resultant is polished with a polishing apparatus. The oats having been shed and polished are dried by heating, and then simmered under saturated steam at 100° C. or more for several tens of minutes. The oats thus simmered are flaked to a thickness of 0.4 to 1.2 mm, and then dried. The oats thus dried are cut into 2 to 6 pieces to obtain grain processed food.

Another example of the processes for obtaining grain processed food using oats will be described (FIG. 1(b)). Oats are charged in a shedding apparatus to remove hull (shedding), and then, the resultant is polished with a polishing apparatus. The oats having been shed and polished are cut into 2 to 6 pieces, and then, simmered under saturated steam at 100° C. or more for several tens of minutes. The oats thus simmered are flaked to a thickness of 0.4 to 1.2 mm, and then dried to obtain grain processed food.

A still another example of the processes for obtaining grain processed food using barley will be described (FIG. 1(c)). Barley having been shed and polished is charged in a high pressure furnace to be simmered at 110 to 140° C. The barley thus simmered is cooled, adjusted to prescribed water content and temperature, and then flaked to a thickness of 0.5 to 1.5 mm. The barley thus flaked is dried or roasted at 200° C. or more for 20 seconds (to be swollen), and then, the resultant is cut into a size of 1.5 to 12.0 mm in terms of a sieve opening size to obtain grain processed food.

A still another example of the processes for obtaining grain processed food using barley will be described (FIG. 1(d)). Barley having been shed and polished is cut into 2 to 4 pieces, and then charged in a high pressure furnace to be simmered at 110 to 140° C. The barley thus simmered is cooled, adjusted to prescribed water content and temperature, and then flaked to a thickness of 0.5 to 1.5 mm. The barley thus flaked is dried, or roasted at 200° C. or more for 20 seconds (to be swollen) to obtain grain processed food.

In the step (D) of the method for producing grain mixed ground meat of the present invention, the grain processed food obtained in the step (C) is mixed with ground meat to obtain grain mixed ground meat. Examples of the ground meat used in the present invention include ground meat for meat processed food such as a hamburger, a meat ball, a meatball, a gyoza, a meat bun, a shaomai, a Japanese potato croquette, a ground meat cutlet, a hamburger patty, a terrine, a patty, and corned beef; ground meat for a sausage, a ham, a steak, yakiniku, roast beef, shabushabu, fried chicken, and jerky; and ground meat for flavored ground meat, flavored ground meat for taco rice, and a meat sauce. Besides, in the present invention, the grain mixed ground meat can be processed into any shape in accordance with a form of target food, such as a block shape, a shape of thick cut meat, a shape of sliced meat, or a minced form, and in addition, can be cooked with heat similarly to meat by grilling, boiling, frying, deep frying, steaming and the like.

A mixing ratio between ground meat and the grain processed food can be appropriately adjusted to, for example, ground meat:grain processed food of 95:5, 90:10, 85:15, 80:20, 75:25, 70:30, 65:35, 60:40, 55:45, 50:50, 45:55, 40:60, 35:65, 30:70, 25:75, 20:80, 15:85, 10:90, 5:95 or the like. For example, when the texture of meat is desired to be enhanced to increase the amount of meat juice, the ratio of ground meat:grain processed food is set to 90:10; and when the amount of nutrients of grain is desired to increase to enhance a healthy aspect of the grain, the ratio of ground meat:grain processed food is set to 20:80. Thus, the mixing ratio between ground meat and the grain processed food can be appropriately changed in accordance with the purpose of a final product of the grain mixed ground meat.

As the grain processed food to be mixed with ground meat, for example, only grain processed food obtained through the same process may be used (for example, only the grain processed food obtained through the process exemplified in FIG. 1(a) may be used), or a mixture of grain processed food respectively obtained through different processes may be used (for example, a mixture of the grain processed food obtained through the process exemplified in FIG. 1(a) and the grain processed food obtained through the process exemplified in FIG. 1(b) may be used). Besides, only grain processed food obtained from the same type of grain may be used (for example, only grain processed food obtained from oats may be used), or a mixture of grain processed food respectively obtained from two or more types of grain may be used (for example, a mixture of grain processed food obtained from oats, and grain processed food obtained from barley may be used).

As for timing of mixing ground meat with the grain processed food, for example, a method (i) in which ground meat is obtained by grinding meat, and the grain processed food is mixed with the ground meat, or a method (ii) in which the grain processed food is precedently added to meat, and the resultant meat is ground to obtain ground meat mixed with the grain process food can be employed.

In the present invention, ground meat may further include, as a constituent raw material, water, a fat or oil, a seasoning (including an umami component such as an amino acid), an acidulant, a bittering agent, spices, a sweetener, an antioxidant, a colorant, a coloring agent, a perfume, a stabilizer, a preservative, an enzyme, a swelling agent, a gelling agent, and the like if necessary in addition to the grain processed food.

### (2. Grain Processed Food)

Grain processed food of the present invention is to be mixed with ground meat, and is grain processed food having been simmered and flaked. The detailed description of the grain, the ground meat, the simmering and the flaking is the same as that given above.

In another aspect of the present invention, the grain processed food is to be mixed with ground meat, and is grain processed food having been simmered, flaked, and cut. The detailed description of the grain, the ground meat, the simmering, the flaking and the cutting is the same as that given above.

In still another aspect of the present invention, the grain processed food is to be mixed with ground meat, and is grain processed food having been simmered and flaked and having a thickness of 0.3 to 2.4 mm. The detailed description of the grain, the ground meat, the simmering and the flaking is the same as that given above.

### (3. Grain Mixed Ground Meat)

Grain mixed ground meat of the present invention includes the above-described grain processed food of the present invention, and more specifically, is obtained by mixing the grain processed food of the present invention with ground meat. The detailed description of the ground meat is the same as that given above, the grain mixed ground meat can be processed into any shape in accordance with a form of target food, such as a block shape, a shape of thick cut meat, a shape of sliced meat, or a minced form, and in addition, can be cooked with heat similarly to meat by grilling, boiling, frying, deep frying, steaming or the like.

A mixing ratio between the ground meat and the grain processed food, the timing of mixing the grain processed food with the ground meat, and an ingredient to be included as a constituent raw material are the same as those described above.

### (4. Summary)

As described so far, a method for producing grain mixed ground meat, grain processed food, and grain mixed ground meat in which texture, flavor and appearance can be adjusted, an amount of ground meat to be used can be reduced, and a nutrient of grain can be added can be provided.

According to the present invention, the texture, the flavor, the appearance and the fillingness of the grain mixed ground meat can be adjusted to desired levels by changing the thickness of flaking the grain, the size of cutting it, the extent of drying or roasting it, the mixing ratio with the grain processed food, and the like.

For example, when grain processed food obtained by flaking the grain to a large thickness and cut the grain into a large size is mixed with ground meat, grain mixed ground meat that can be felt sufficiently filling can be realized. On the other hand, when grain processed food obtained by flaking the grain to a small thickness and cut the grain into a small size is mixed with ground meat, grain mixed ground meat having the original texture and appearance of the ground meat retained can be realized.

For example, when grain processed food obtained by setting the degree of drying high is mixed with ground meat, grain mixed ground meat having definite chewy texture can be realized, and for example, when grain processed food obtained by setting the degree of roasting high is mixed with ground meat, grain mixed ground meat provided with aromatic flavor and a deep colored appearance can be realized.

As for the mixing ratio between ground meat and the grain processed food, for example, when a mixing ratio of the grain processed food is low, grain mixed ground meat having the texture of meat enhanced and including a large amount of meat juice can be realized, and when the mixing ratio of the grain processed food is high, grain mixed ground meat in which nutrients of the grain are increased and a healthy aspect of the grain is enhanced can be realized.

Besides, according to the present invention, soy beans, konjac, okara and the like used in conventional meat-like food are not used, but the grain processed food is mixed, and thus, grain mixed ground meat comparable in the original texture, appearance, taste, aroma and fillingness of ground meat can be obtained. When the grain processed food is mixed with ground meat in a desired ratio, an amount of meat to be used is reduced to reduce a lipid content, and nutrients (dietary fiber and the like) of the grain not originally contained in the meat can be simultaneously added, and as a result, grain mixed ground meat contributing to health promotion of consumers can be provided.

### EXAMPLES

Now, the present invention will be specifically described by way of examples. It is noted that the present invention is not limited to these examples.

### Example 1

Oats were charged in a shedding apparatus to remove hull (shedding), and then polished with a polishing apparatus. The oats thus polished were boiled with steam (100° C.) for several tens of minutes, and then flaked to a thickness of 0.9 mm with a heated flaking roller. Thereafter, the resultant was dried by hot air drying to a moisture value of 14% or less, and then cut into 4 pieces with a cutting machine to obtain oats processed food.

The oats processed food (grain processed food) obtained as described above was mixed with ground beef and pork in a ratio of 1:1 (content of the grain processed food: 50%), and the resultant was formed into a hamburger shape. This hamburger was grilled to be used in the following sensory test.

The sensory test was conducted by three panelists in accordance with the following scoring criteria. As a control, a commercially available hamburger having been grilled was used. Evaluation items were 5 items of “appearance”, “aroma”, “taste”, “texture”, and “fillingness”. The scores of the 3 panelists were added up to calculate an average for each evaluation item.
5: equivalent to control
4: slightly different from control
3: rather different from control
2: different from control
1: greatly different from control

Results of the sensory test are shown in Table 1. The averages of all the 5 items of “appearance”, “aroma”, “taste”, “texture”, and “fillingness” were 4 (slightly different from control) or more. In particular, the averages were high in “appearance” and “fillingness”, and thus, the hamburger of this example was comparable to the hamburger used as the control.

TABLE 1

| Evaluation Item | Panelist 1 | Panelist 1 | Panelist 1 | Average |
|---|---|---|---|---|
| Appearance | 3 | 5 | 5 | 4.3 |
| Aroma | 4 | 4 | 4 | 4.0 |
| Taste | 4 | 3 | 5 | 4.0 |
| Texture | 3 | 4 | 5 | 4.0 |
| fillingness | 4 | 4 | 5 | 4.3 |

In this manner, the hamburger obtained by mixing the grain processed food of the present example with ground meat in a ratio of 50% and grilling the resultant was comparable to the commercially available hamburger in “appearance”, “aroma”, “taste”, “texture”, and “fillingness”, and it was revealed that an amount of meat to be used can be reduced by using the grain processed food of the present example.

### Example 2

Oats were charged in a shedding apparatus to remove hull (shedding), and then polished with a polishing apparatus. The oats thus polished were cut into 6 pieces with a cutting machine. The resultant was boiled with steam (100° C.) for several tens of minutes, and then flaked to a thickness of 1.2 mm with a heated flaking roller. Thereafter, the resultant was dried by hot air drying to a moisture value of 14% or less to obtain oats processed food.

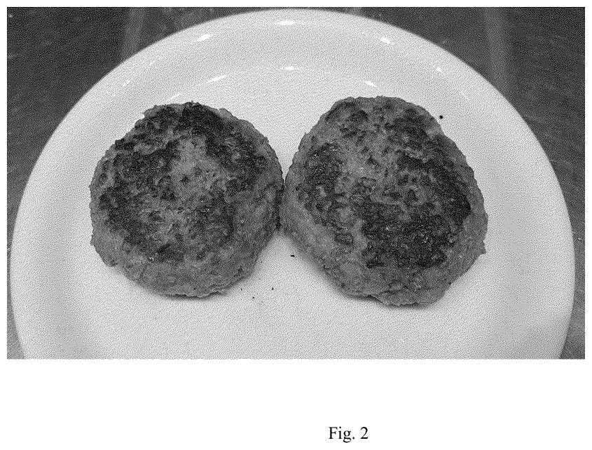

The oats processed food (grain processed food) obtained as described above was mixed with ground beef and pork (beef: 75%, pork: 25%) in a ratio of 2:3 (content of the grain processed food: 40%), and the resultant was formed into a hamburger shape. This hamburger was grilled to be used in the following sensory test. FIG. 2 is a photograph of the hamburger of this example thus cooked.

The sensory test was conducted by four panelists in accordance with the following scoring criteria. As a control, a commercially available hamburger having been grilled was used. Evaluation items were 6 items of “appearance”, “aroma”, “taste”, “texture”, “chewy texture” and “feeling of satisfaction”. The scores of the four panelists were added up to calculate an average for each evaluation item.
5: equivalent to control
4: slightly different from control
3: rather different from control
2: different from control
1: greatly different from control

Results of the sensory test are shown in Table 2. All the panelists evaluated the hamburger as “5: equivalent to control” in “appearance”, “aroma”, “texture”, “chewing texture” and “feeling of satisfaction”. Besides, “taste” was evaluated as an average of 4 (slightly different from control) or more, and thus, the hamburger of this example was comparable to the hamburger used as the control.

TABLE 2

| | Panelist 1 | Panelist 2 | Panelist 3 | Panelist 4 | Average |
|---|---|---|---|---|---|
| Appearance | 5 | 5 | 5 | 5 | 5.0 |
| Aroma | 5 | 5 | 5 | 5 | 5.0 |
| Taste | 4 | 4 | 5 | 5 | 4.5 |
| Texture | 5 | 5 | 5 | 5 | 5.0 |
| Chewy Texture | 5 | 5 | 5 | 5 | 5.0 |
| Feeling of | 5 | 5 | 5 | 5 | 5.0 |
| Satisfaction | | | | | |

In this manner, the hamburger obtained by mixing the grain processed food of the present example with ground meat in a ratio of 40% and grilling the resultant provided “appearance”, “aroma”, “texture”, “chewy texture” and “feeling of satisfaction” equivalent to those of the commercially available hamburger, and was comparable in “taste”, and it was thus revealed that an amount of meat to be used can be reduced by using the grain processed food of the present example.

### Example 3

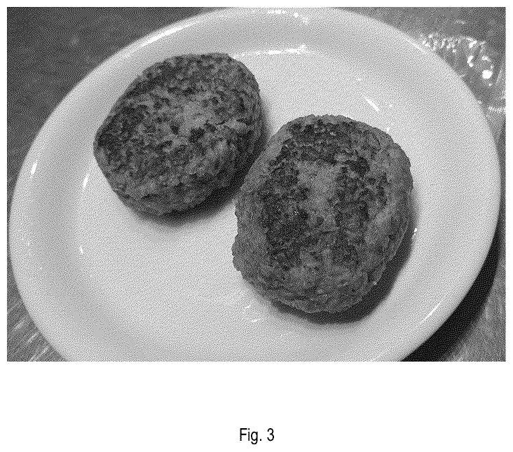

The oats processed food (grain processed food) obtained in Example 2 was mixed with ground beef (beef: 100%) in a ratio of 2:3 (content of the grain processed food: 40%), and the resultant was formed into a hamburger shape. This hamburger was grilled to be used in the following sensory test. FIG. 3 is a photograph of the hamburger of this example thus cooked.

The sensory test was conducted by four panelists in accordance with the same scoring criteria as those of Example 2. As a control, a commercially available hamburger having been grilled was used.

Results of the sensory test are shown in Table 3. All the panelists evaluated the hamburger as “5: equivalent to control” in “appearance”, “aroma”, and “chewing texture”. Besides, “taste”, “texture”, and “feeling of satisfaction” were evaluated as an average of 4 (slightly different from control) or more, and thus, the hamburger of this example was comparable to the hamburger used as the control.

TABLE 3

| | Panelist 1 | Panelist 2 | Panelist 3 | Panelist 4 | Average |
|---|---|---|---|---|---|
| Appearance | 5 | 5 | 5 | 5 | 5.0 |
| Aroma | 5 | 5 | 5 | 5 | 5.0 |
| Taste | 4 | 4 | 5 | 5 | 4.5 |
| Texture | 3 | 5 | 5 | 5 | 4.5 |
| Chewy Texture | 5 | 5 | 5 | 5 | 5.0 |
| Feeling of | 4 | 5 | 5 | 5 | 4.8 |
| Satisfaction | | | | | |

In this manner, the hamburger obtained by mixing the grain processed food of the present example with ground meat in a ratio of 40% and grilling the resultant was equivalent to the commercially available hamburger in “appearance”, “aroma”, and “chewy texture”, and was comparable in “taste”, “texture”, and “feeling of satisfaction”, and it was revealed that an amount of meat to be used can be reduced by using the grain processed food of the present example.

### Example 4

Processed corn (corn grits) was charged in a high pressure furnace to be simmered at 130° C. for 105 minutes. The corn thus simmered was cooled, adjusted to prescribed water content and temperature, and flaked to a thickness of 1.5 mm with a flaking roller. The corn thus flaked was dried by hot air drying to a moisture value of 14% or less, and the resultant was cut into a size of 3.23 mm in terms of a sieve opening size to obtain corn processed food.

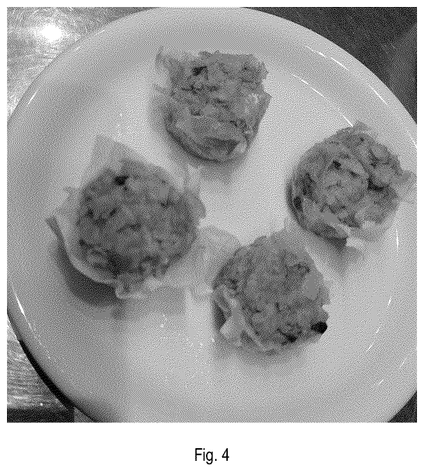

The corn processed food (grain processed food) obtained as described above was mixed with ground pork in a ratio of 2:3 (content of the grain processed food: 40%), and the resultant was wrapped with a shaomai skin. The resultant shaomai was steamed to be used in the following sensory test. FIG. 4 is a photograph of the shaomai of this example thus cooked.

The sensory test was conducted by four panelists in accordance with the same scoring criteria as those of Example 2. As a control, a commercially available shaomai having been steamed was used.

Results of the sensory test are shown in Table 4. “Aroma”, “taste”, “texture”, “chewy texture”, and “feeling of satisfaction” were evaluated as an average of 4 (slightly different from control) or more, and thus, the shaomai of this example was comparable to the shaomai used as the control.

TABLE 4

| | Panelist 1 | Panelist 2 | Panelist 3 | Panelist 4 | Average |
|---|---|---|---|---|---|
| Appearance | 4 | 4 | 3 | 4 | 3.8 |
| Aroma | 3 | 5 | 3 | 5 | 4.0 |
| Taste | 4 | 5 | 4 | 5 | 4.5 |
| Texture | 4 | 4 | 4 | 5 | 4.3 |
| Chewy Texture | 4 | 5 | 4 | 5 | 4.5 |
| Feeling of | 5 | 5 | 4 | 5 | 4.8 |
| Satisfaction | | | | | |

In this manner, the shaomai obtained by mixing the grain processed food of the present example with ground meat in a ratio of 40% and cooking the resultant was comparable to the commercially available shaomai in “aroma”, “taste”, “texture”, “chewy texture” and “feeling of satisfaction”, and it was revealed that an amount of meat to be used can be reduced by using the grain processed food of the present example.

### Example 5

Processed corn (corn grits) was charged in a high pressure furnace to be simmered at 130° C. for 100 minutes. The corn thus simmered was cooled, adjusted to prescribed water content and temperature, and flaked to a thickness of 1.5 mm with a flaking roller. The corn thus flaked was roasted (to be swollen) with a roasting apparatus at 250° C. for 5 seconds to set a moisture value to 7% or less, and thereafter, the resultant was cut into a size of 2 mm in terms of a sieve opening size to obtain corn processed food 1.

Processed corn (corn grits) was cut into 6 pieces with a cutting machine, and the resultant was charged in a high pressure furnace to be simmered at 130° C. for 60 minutes. The corn thus simmered was cooled, adjusted to prescribed water content and temperature, and flaked to a thickness of 1.0 mm with a flaking roller. Thereafter, the resultant was roasted (to be swollen) with a roasting apparatus at 250° C. for 5 seconds to set a moisture value to 7% or less, and thus corn processed food 2 was obtained.

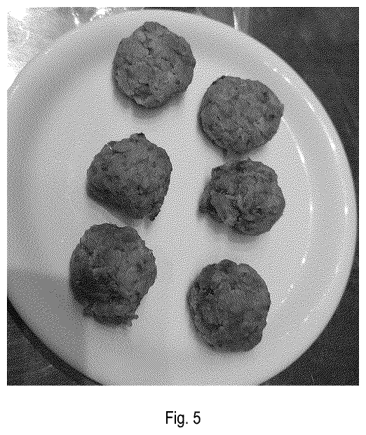

The corn processed food 1 (grain processed food) and the corn processed food 2 (grain processed food) obtained as described above were mixed with ground pork in a ratio of 13:13:40 (content of the grain processed food: 39%), and the resultant was formed into a meatball shape. The meatball was grilled to be used in the following sensory test. FIG. 5 is a photograph of the meatball of this example thus cooked.

The sensory test was conducted by four panelists in accordance with the same scoring criteria as those of Example 2. As a control, a commercially available meatball having been grilled was used.

Results of the sensory test are shown in Table 5. All the panelists evaluated the meatball as “5: equivalent to control” in “feeling of satisfaction”. In addition, “aroma”, “taste”, “texture”, and “chewy texture” were evaluated as an average of 4 (slightly different from control) or more, and thus, the meatball of this example was comparable to the meatball used as the control.

TABLE 5

| | Panelist 1 | Panelist 2 | Panelist 3 | Panelist 4 | Average |
|---|---|---|---|---|---|
| Appearance | 3 | 4 | 4 | 3 | 3.5 |
| Aroma | 3 | 5 | 5 | 5 | 4.5 |
| Taste | 4 | 5 | 4 | 5 | 4.5 |
| Texture | 3 | 4 | 4 | 5 | 4.0 |
| Chewy Texture | 4 | 5 | 4 | 5 | 4.5 |
| Feeling of | 5 | 5 | 5 | 5 | 5.0 |
| Satisfaction | | | | | |

In this manner, the meatball obtained by mixing the grain processed food of the present example with ground meat in a ratio of 39% and grilling the resultant was equivalent to the commercially available meatball in “feeling of satisfaction”, and was comparable in “aroma”, “taste”, “texture”, and “chewy texture”, and it was revealed that an amount of meat to be used can be reduced by using the grain processed food of the present example.

### Example 6

Grain processed foods derived from various grains were prepared, sizes of the resultants were measured, and appearances thereof were photographed.

### (1. Oats: Flaking Followed by Cutting)

Oats (whole oats) were charged in a shedding apparatus to remove hull (shedding), and then polished with a polishing apparatus. The oats thus polished were boiled with steam (100° C.) for several tens of minutes, and then flaked to a thickness of 1.2 mm with a heated flaking roller. Thereafter, the resultant was dried by hot air drying to a moisture value of 14% or less, and the resultant was cut into 2 pieces, 4 pieces, or 6 pieces with a cutting machine to obtain oats processed food.

The sizes and the appearances (photographs) of the respective oats processed foods obtained as described above were as follows:

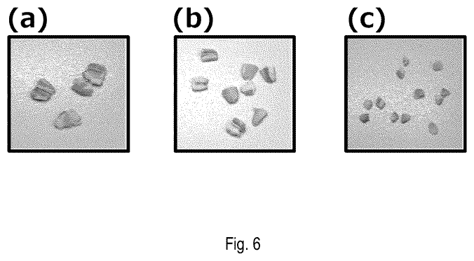

Food cut into 2 pieces: 4.26 mm in length, 4.23 mm in width, and 1.2 mm in thickness (FIG. 6(a))

Food cut into 4 pieces: 4.35 mm in length, 2.45 mm in width, and 1.2 mm in thickness (FIG. 6(b))

Food cut into 6 pieces: 2.28 mm in length, 2.31 mm in width, and 1.18 mm in thickness (FIG. 6(c))

### (2. Oats: Cutting Followed by Flaking)

Oats were charged in a shedding apparatus to remove hull (shedding), and then polished with a polishing apparatus. The oats thus polished were cut into 2 pieces or 6 pieces with a cutting machine. The resultant was boiled with steam (100° C.) for several tens of minutes, and then flaked to a thickness of 0.4 mm, 0.9 mm or 1.2 mm with a heated flaking roller. Thereafter, the resultant was dried by hot air drying to a moisture value of 14% or less to obtain oats processed food.

The sizes and appearances (photographs) of the respective oats processed foods obtained as described above were as follows:

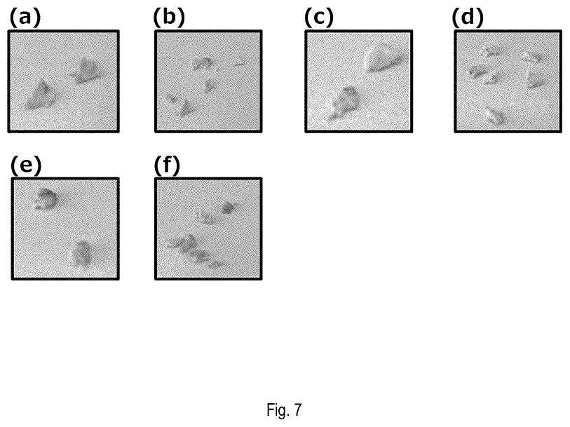

Food flaked to 0.4 mm and cut into 2 pieces: 5.9 mm in length, 4.45 mm in width, and 0.38 mm in thickness (FIG. 7(a))

Food flaked to 0.4 mm and cut into 6 pieces: 3.1 mm in length, 2.2 mm in width, and 0.41 mm in thickness (FIG. 7(b))

Food flaked to 0.9 mm and cut into 2 pieces: 5.56 mm in length, 4.25 mm in width, and 0.89 mm in thickness (FIG. 7(c))

Food flaked to 0.9 mm and cut into 6 pieces: 3.65 mm in length, 1.95 mm in width, and 0.87 mm in thickness (FIG. 7(d))

Food flaked to 1.2 mm and cut into 2 pieces: 4.73 mm in length, 3.29 mm in width, and 1.18 mm in thickness (FIG. 7(e))

Food flaked to 1.2 mm and cut into 6 pieces: 2.07 mm in length, 1.75 mm in width, and 1.14 mm in thickness (FIG. 7(f))

### (3. Corn: Flaking Followed by Cutting)

Processed corn (corn grits) was charged in a high pressure furnace to be simmered at 130° C. for 100 minutes. The corn thus simmered was cooled, adjusted to prescribed water content and temperature, and then flaked to a thickness of 0.5 mm with a flaking roller. The corn thus flaked was roasted (to be swollen) at 250° C. for 5 seconds with a roasting apparatus to set a moisture value to 7% or less, and thereafter, the resultant was cut into 9 US mesh (2 mm in terms of a sieve opening size) to obtain corn processed food.

The size and appearance (photograph) of the corn processed food obtained as described above were as follows:

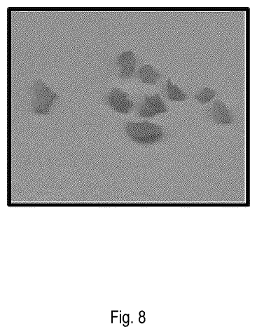

2.63 mm in length, 1.83 mm in width, and 0.87 mm in thickness (FIG. 8)

### (4. Corn: Cutting Followed by Flaking (Drying))

Processed corn (corn grits) was cut into 6 to 8 pieces with a cutting machine, and the resultant was charged in a high pressure furnace to be simmered at 130° C. for 60 minutes. The corn thus simmered was cooled, adjusted to prescribed water content and temperature, and then flaked to a thickness of 0.5 mm, 0.8 mm, or 1.2 mm with a flaking roller. Thereafter, the resultant was dried by hot air drying to a moisture value of 14% or less to obtain corn processed food.

The sizes and appearances (photographs) of the respective corn processed foods obtained as described above were as follows:

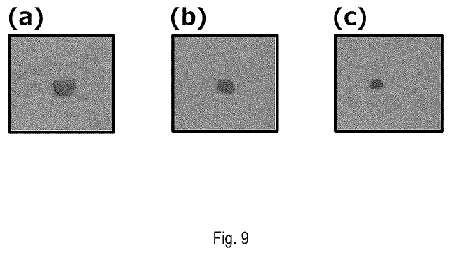

Food flaked to 0.5 mm: 9.37 mm in length, 7.67 mm in width, and 0.51 mm in thickness (FIG. 9(a))

Food flaked to 0.8 mm: 6.66 mm in length, 6.55 mm in width, and 0.82 mm in thickness (FIG. 9(b))

Food flaked to 1.2 mm: 4.49 mm in length, 4.13 mm in width, and 1.19 mm in thickness (FIG. 9(c))

### (5. Corn: Cutting Followed by Flaking (Roasting/Swelling))

Processed corn (corn grits) was cut into 6 to 8 pieces with a cutting machine, and the resultant was charged in a high pressure furnace to be simmered at 130° C. for 60 minutes. The corn thus simmered was cooled, adjusted to prescribed water content and temperature, and then flaked to a thickness of 0.5 mm, 0.8 mm, or 1.2 mm with a flaking roller. Thereafter, the resultant was roasted (to be swollen) at 250° C. for 5 seconds with a roasting apparatus to set a moisture value to 7% or less, and thus corn process food was obtained.

The sizes and appearances (photographs) of the respective corn processed foods obtained as described above were as follows:

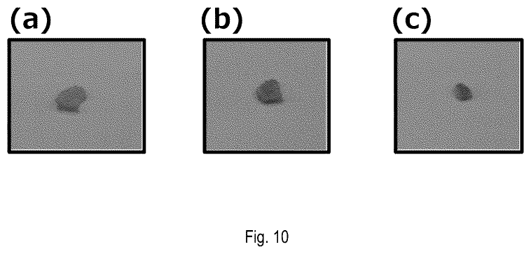

Food flaked to 0.5 mm: 10.21 mm in length, 6.9 mm in width, and 0.84 mm in thickness (FIG. 10(a))

Food flaked to 0.8 mm: 7.99 mm in length, 6.04 mm in width, and 1.16 mm in thickness (FIG. 10(b))

Food flaked to 1.2 mm: 5.51 mm in length, 4.18 mm in width, and 1.53 mm in thickness (FIG. 10(c))

When the grain processed food of the present example is mixed with ground meat, grain mixed ground meat comparable in original texture, appearance, taste, aroma, and fillingness of ground meat can be obtained, and in addition, an amount of meat to be used can be reduced to reduce a lipid content, and nutrients (dietary fiber and the like) of the grain not originally contained in the meat can be simultaneously added, and as a result, grain mixed ground meat contributing to health promotion of consumers can be provided.

It is noted that the present invention can be practiced in various forms and modifications without departing from spirits and scope in a broad sense of the present invention. Besides, the above-described embodiment is given merely for describing the present invention and does not limit the scope of the present invention. In other words, the scope of the present invention is determined not by the embodiment but by the appended claims. Various modifications made within the scope of the appended claims and equivalent thereof are regarded as within the scope of the present invention.

The present invention is based upon Japanese Patent Application No. 2021-102106, filed on Jun. 21, 2021. The description, claims and drawings of Japanese Patent Application No. 2021-102106 are incorporated herein by reference.

1-10. (canceled)

11. A method for producing grain mixed ground meat, comprising:
a step (A) of simmering grain having been shed and polished;
a step (B) of flaking the grain having been simmered in the foregoing step;
a step (C) of drying or roasting the grain having been flaked in the foregoing step to obtain grain processed food having a moisture value of 14% or less; and
a step (D) of mixing the grain processed food obtained in the foregoing step with ground meat to obtain grain mixed ground meat,
wherein the grain is flaked to a thickness of 0.3 to 2.4 mm in the step (B),
a mixing ratio between the ground meat and the grain processed food is the ground meat: the grain processed food of 70:30 to 10:90 in the step (D).

12. The production method according to claim 11,
further comprising a step of cutting the grain,
wherein the grain is cut into 2 to 15 pieces or cut into a size of 1.5 to 12.0 mm in terms of a sieve opening size.

13. The production method according to claim 12,
wherein the grain is simmered in the step (A) after the grain having been shed and polished is cut.

14. The production method according to claim 12,
wherein the grain is cut in the step (C) to obtain the grain processed food after the grain having been flaked in the step (B) is dried or roasted.

15. Grain processed food having a moisture value of 14% or less; and having been simmered, and flaked to a thickness of 0.3 to 2.4 mm, to be mixed with ground meat in which the ground meat: the grain processed food is mixed at a mixing ratio of 70:30 to 10:90.

16. Grain processed food according to claim 15,
wherein the grain processed food is cut into 2 to 15 pieces or cut into a size of 1.5 to 12.0 mm in terms of a sieve opening size.

17. Grain mixed ground meat, comprising the grain processed food according to claim 15.

18. Grain mixed ground meat, comprising the grain processed food according to claim 16.
